(19) United States
(12) Patent Application Publication
(10) Pub. No.: US 2011/0020653 A1
(43) Pub. Date: Jan. 27, 2011

(54) COMPOSITE CUSHIONING STRUCTURE

(75) Inventors: Catherine E. Kearns, Haverhill, MA (US); Frank M. Keese, Cambridge, NY (US); Matthew Morin, Putnam, CT (US); Mark Sinofsky, Bedford, NH (US); David H. Williams, Cohoes, NY (US)

Correspondence Address: LARSON NEWMAN & ABEL, LLP, 5914 WEST COURTYARD DRIVE, SUITE 200, AUSTIN, TX, 78730, US

(73) Assignee: Saint-Gobain Performance Plastics Corporation, Aurora, OH (US)

(21) Appl. No.: 12/842,535

(22) Filed: Jul. 23, 2010

Related U.S. Application Data
(60) Provisional application No. 61/228,067, filed on Jul. 23, 2009.

(51) Int. Cl. B32B 27/00

(52) U.S. Cl. 428/422; 428/421

(57) ABSTRACT

The disclosure is directed to a composite cushioning structure including a fluoropolymer layer having a major surface and a polymeric layer overlying the major surface of the fluoropolymer layer. The composite structure has wherein the composite structure can withstand a hot press at a temperature of at least about 330° C. to about 400° C. and a pressure of about 3 MPa to about 5 MPa for at least about 15 cycles.

### CROSS-REFERENCE TO RELATED APPLICATION(S)

The present application claims priority from U.S. Provisional Patent Application No. 61/228,067, filed Jul. 23, 2009, entitled “Composite Cushioning Structure,” naming inventors Catherine E. Kearns, Frank M. Keese, Matthew Morin, Mark Sinofsky, and David H. Williams, which application is incorporated by reference herein in its entirety.

### FIELD OF THE DISCLOSURE

This disclosure, in general, relates to a composite cushioning structure and methods for making such structures.

### BACKGROUND

In the construction of LCD electronic products, it has been necessary to adhere the electronic components of a circuit to the electronic components of a display screen. To accomplish this, a heat activated anisotropic conductive film (ACF) is used between the two sets of electronic components. The bonding of the circuit to the display screen electronic components is typically accomplished using a heat seal process using a hot press, i.e. heat and pressure, to activate the ACF.

During the heat seal process, the electronic components need to be protected from crushing or marring applied by the steel tool head and non-planarity needs to be accommodated. At the same time, the tool head needs to be protected from the ACF that may adhere to the tool head from the exposed areas between the electronic components. Traditionally, the modes of protection have been from skived PTFE (2 mils or 6 mils), silicone sheets, PTFE coated fabric (2.0 mils) or a combination of PTFE, silicone, and a metal sheet. These materials are in the form of continuous roll of material so that the sheet can be indexed forward providing a virgin area in the heat seal area. Problems have arisen with these materials regarding either sticking to the electronic components or failing after a short number of cycles, for instance, less than 10 cycles.

With the increase in the size of LCD television and economic pressures, interest has arose to provide a composite that serves to cushion the electronic components from the tool head, level the pressure along the full length of the electronic components, and release from the ACF. The expectation is that a cushioning product would have the ability to maintain its properties under multiple heat-sealing cycles, reducing cost per cycle.

Hence, it would be desirable to provide an improved cushioning material as well as a method for manufacturing such a cushioning material.

### SUMMARY

In an embodiment, a composite cushioning structure is provided. The composite cushioning structure includes a fluoropolymer layer having a major surface and a polymeric layer overlying the major surface of the fluoropolymer layer. The composite structure can withstand a hot press at a temperature of at least about 330° C. to about 400° C. and a pressure of about 3 MPa to about 5 MPa for at least about 15 cycles.

In another exemplary embodiment, a composite cushioning structure is provided. The composite structure includes a fluoropolymer layer having a major surface and a polymeric layer overlying the major surface of the fluoropolymer layer. The polymeric layer includes a thermally conductive filler present at up to about 75% by weight of the total weight of the polymeric layer. The composite structure can withstand a hot press at a temperature of at least about 330° C. to about 400° C. and a pressure of about 3 MPa to about 5 MPa for at least about 15 cycles.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary composite cushioning structure.

### DETAILED DESCRIPTION

In a particular embodiment, a composite cushioning structure includes a fluoropolymer layer having a major surface. The composite structure further includes a polymeric layer overlying the major surface of the fluoropolymer layer. In an embodiment, the fluoropolymer layer may be disposed directly on and directly contacts the major surface of the polymeric layer without any intervening layer or layers. In an embodiment, the composite cushioning structure is placed directly in contact with a heat platen of a hot press. Typically, the hot press is used to heat seal an anisotropic conductive film (ACF) that is sandwiched between two opposing layers of electronic components. In an exemplary embodiment, the composite cushioning structure offers cushioning to the electronic components from the heat seal platen. Further, the composite cushioning structure offers leveling of pressure from the heat seal platen on the electronic components during the heat seal process.

An exemplary fluoropolymer used to form the fluoropolymer layer includes a homopolymer, copolymer, terpolymer, or polymer blend formed from a monomer, such as tetrafluoroethylene, hexafluoropropylene, chlorotrifluoroethylene, trifluoroethylene, vinylidene fluoride, vinyl fluoride, perfluoropropyl vinyl ether, perfluoromethyl vinyl ether, or any combination thereof. For example, the fluoropolymer is polytetrafluoroethylene (PTFE). Exemplary fluoropolymers films may be cast, skived, or extruded. A polytetrafluoroethylene is commercially available from SGPPL.

Further exemplary fluoropolymers include a fluorinated ethylene propylene copolymer (FEP), a copolymer of tetrafluoroethylene and perfluoropropyl vinyl ether (PFA), a copolymer of tetrafluoroethylene and perfluoromethyl vinyl ether (MFA), a copolymer of ethylene and tetrafluoroethylene (ETFE), a copolymer of ethylene and chlorotrifluoroethylene (ECTFE), polychlorotrifluoroethylene (PCTFE), poly vinylidene fluoride (PVDF), a terpolymer including tetrafluoroethylene, hexafluoropropylene, and vinylidenefluoride (THV), or any blend or any alloy thereof. For example, the fluoropolymer may include FEP. In a further example, the fluoropolymer may include a copolymer of tetrafluoroethylene and perfluoropropyl vinyl ether (PFA). In an exemplary embodiment, the fluoropolymer may be a polymer crosslinkable through radiation, such as e-beam. An exemplary crosslinkable fluoropolymer may include ETFE, THV, PVDF, or any combination thereof.

In an embodiment, the fluoropolymer layer may be treated to improve adhesion of the fluoropolymer layer to the layer it directly contacts. In an embodiment, the treatment may include surface treatment, chemical treatment, sodium etching, use of a primer, or any combination thereof. In an embodiment, the treatment includes chemical treatment, such as sodium naphthalene surface treatment or sodium ammonia surface treatment. In an embodiment, the treatment may include corona treatment, UV treatment, electron beam treatment, flame treatment, scuffing, or any combination thereof.

Typically, the fluoropolymer layer has a thickness of about 0.1 mils to about 3.0 mils. For example, the fluoropolymer layer may have a thickness of about 0.15 mils to about 0.30 mils. In an embodiment, the fluoropolymer layer may have a thickness of about 2.0 mils to 3.0 mils.

The polymeric layer overlies the fluoropolymer layer. In an embodiment, the polymeric layer directly contacts the fluoropolymer layer. The polymeric layer includes polymeric materials such as thermoplastics and thermosets. An exemplary polymeric material may include silicones. In an embodiment, the polymeric material includes silicones that may include polyalkylsiloxanes, such as silicone polymers formed of a precursor, such as dimethylsiloxane, diethylsiloxane, dipropylsiloxane, methylethylsiloxane, methylpropylsiloxane, or combinations thereof. In an embodiment, the silicone is a high consistency gum rubber (HCR). An exemplary silicone is a liquid silicone rubber (LSR), such as a cross-linkable liquid silicone rubber. Commercially available cross-linkable liquid silicone rubber is a two-part liquid silicone rubber. The silicone may be catalyzed, such as platinum catalyzed, peroxide catalyzed, or combination thereof. Such liquid silicone rubbers may be available from, for example, Wacker and Dow Corning. Further polymeric materials may include phenolics, epoxys, or any combination thereof. Any polymeric layer suitable for cushioning, leveling, and hot press conditions is envisioned.

In an embodiment, the polymeric layer may include a thermally conductive filler. In a particular embodiment, the thermally conductive filler is present at an amount of greater than about 20%, such as greater than about 25%, such as greater than about 30%, such as greater than about 40%, such as greater than about 50%, such as greater than 60%, or even up to about 75% by weight of the total weight of the polymeric layer. Any thermally conductive filler may be envisioned that improves the conductivity through the polymeric layer. The thermally conductive filler is preferably selected from a variety of materials having a bulk thermal conductivity of between about 0.5 and 1000.0 Watts/meter-K as measured according to ASTM D1530. Examples of suitable thermally conductive fillers include, but are not limited to, boron nitride, aluminum oxide (alumina), aluminum nitride, magnesium oxide, zinc oxide, beryllium oxide, silicon carbide, nickel powder, copper flakes, graphite powder, powdered diamond, iron oxide, carbon black, and mixtures thereof. In an embodiment, the thermally conductive filler is aluminum oxide, aluminum nitride, boron nitride, iron oxide, carbon black, or combinations thereof. In a particular embodiment, the particle size of the thermally conductive filler, the particle size distribution, and filler loading (concentration in the polymeric layer) are selected to maximize packing and thus produce the most efficient thermal conductance. For instance, the particle size of the thermally conductive filler may be between about 2 microns and about 100 microns. In a particular embodiment, the addition of the thermally conductive filler may eliminate the need for a slip layer. In an embodiment, the polymeric layer is substantially free of any silicon oxide, i.e. silicone oxide is not present in the polymeric layer.

Typically, the polymeric layer has a thickness of at least about 5.0 mils. For example, the polymeric layer may have a thickness of about 7.0 mils to about 25.0 mils, such as about 7.0 mils to about 9.0 mils.

In an embodiment, a reinforcing layer may also be used. The reinforcing layer may be disposed in any position within the composite structure to provide reinforcement to the structure. For instance, the reinforcing layer is in contact with the polymeric layer. In an embodiment, the reinforcing layer may overlie a major surface of the polymeric layer. In an embodiment, the reinforcing layer may be substantially embedded in the polymeric layer. “Substantially embedded” as used herein refers to a reinforcing layer wherein at least 25%, such as at least about 50%, or even 100% of the total surface area of the reinforcing layer is embedded in the polymeric layer. In an embodiment, at least about 25% of even about 50% of even about 100% of the polymeric layer is directly in contact with the fluoropolymer layer. The reinforcing layer can be any material that increases the reinforcing properties of the composite structure. For instance, the reinforcing layer may include natural fibers, synthetic fibers, or combination thereof. In an embodiment, the fibers may be in the form of a knit, laid scrim, braid, woven, or non-woven fabric. Exemplary reinforcement fibers include glass, aramids, and the like. In an embodiment, the reinforcement fiber is fiberglass, such as woven fiberglass. The reinforcing layer may have a thickness of less than about 5.0 mils, such as less than about 2.0 mils, or even less than about 1.0 mil.

Optionally, the composite structure further includes slip layer disposed over the polymeric layer. In an embodiment, the slip layer has anti-static properties. An exemplary slip layer improves the release properties of the composite structure, i.e. does not stick, to the tool head of the hot seal press. In a particular embodiment, the slip layer reduces the coefficient of friction of the composite structure. For instance, the slip layer reduces the drag of the composite structure as it is being pulled through the hot press equipment. Typically, the slip layer may be the outermost layer, i.e. the top coat, that is in contact with the heat platen during the hot press process. In an embodiment, the slip layer overlies the polymeric layer without any intervening layers. For instance, when a reinforcing layer is not used, the slip layer may be directly in contact with the polymeric layer. In an embodiment when a reinforcing layer is present, the slip layer may overlie the reinforcement layer and the polymeric layer.

Any thermoplastic or thermoset materials may be envisioned that have slip properties. An exemplary thermoplastic or thermoset material may include silicones. In an embodiment, the polymeric material includes silicones that may include polyalkylsiloxanes, such as silicone polymers formed of a precursor, such as dimethylsiloxane, diethylsiloxane, dipropylsiloxane, methylethylsiloxane, methylpropylsiloxane, or combinations thereof. An exemplary material includes liquid silicone rubber (LSR), such as cross-linkable liquid silicone rubber that may be rendered anti-static. A commercially available cross-linkable liquid silicone rubber is a two-part liquid silicone rubber composition, such as Dow Corning® 3715 Topcoat. The silicone may be catalyzed, such as platinum catalyzed, peroxide catalyzed, or combination thereof. Other liquid silicone rubbers may be available from Wacker. Further slip materials may include phenolics, epoxys, or any combination thereof. Typically, the slip layer has a thickness of less than 1.0 mil, such as about 0.1 mils to about 1.0 mil.

In an embodiment, the slip layer is rendered anti-static. Any reasonable additive may be used to increase the anti-static properties of the slip layer, compared to a material that does not include the additive. Additives that increase the anti-static properties include, for example, amines (quaternary and others), carbon black, esters, metals, carbon and graphite fibers, inorganic fillers such as antimony tin oxide, indium tin oxide, silicon carbide, tin antimony, grey cassiterite, zinc oxide whisker, aluminum powder, copper powder, gold powder, molybdenum powder, nickel powder, silver powders, solid and hollow glass spheres coated with metals, conductive polymers such as polyethylene glycol, and any combination thereof. Typically, the additive is present at an effective amount to provide anti-static properties to the slip layer. In an embodiment, the filler may be added in an amount of up to 4%, such as up to 10% by weight of the total weight of the slip layer.

The layers of the composite structure may possess other properties specific to the intended use. For instance, any one of the layers may contain fillers, mineral fillers, metallic fillers, stabilizers, additives, processing aids, colorants, or any combination thereof to change the appearance or other physical properties of the polymeric layer.

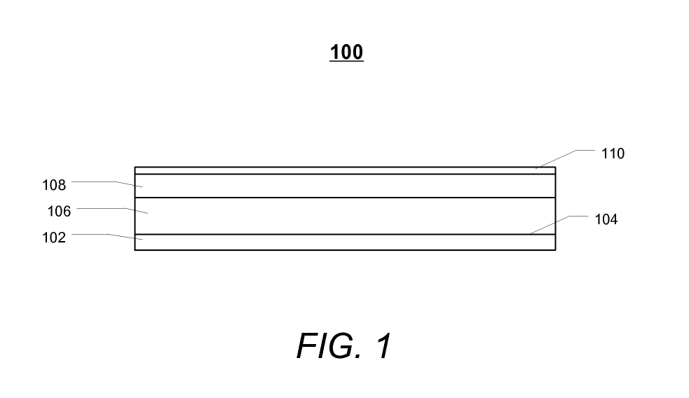

An exemplary embodiment of a composite cushioning structure 100 is illustrated in FIG. 1. The composite structure includes a fluoropolymer layer 102 having a major surface 104. A polymeric layer 106 overlies the major surface 104 of the fluoropolymer layer 102. As seen in FIG. 1, the polymeric layer 106 may directly contact the fluoropolymer layer 102. In an embodiment, the composite structure 100 may include an optional reinforcing layer 108 in contact with the polymeric layer 106. As shown in

FIG. 1, the reinforcing layer 108 may be disposed on the polymeric layer 106. In an embodiment, the composite structure 100 may include an optional slip layer 110 disposed on the reinforcing layer 108.

In an embodiment, the composite structure may be formed through a method that includes providing a fluoropolymer layer. Typically, the fluoropolymer layer may be extruded, cast, or skived by any reasonable method. Providing the fluoropolymer layer may or may not include a carrier structure. In a particular embodiment, the fluoropolymer is cast or coated on a carrier structure. Exemplary carrier structures are removed from the fluoropolymer layer once the composite structure is formed without any physical damage to the composite structure. A typical carrier structure may be a polyimide film. The carrier structure typically has a thickness of 3 mils to about 5 mils. Once the fluoropolymer layer is provided, it may be subject to any reasonable surface treatment. In a particular embodiment, the fluoropolymer is chemically etched, such as sodium naphthalene etched.

The method further includes providing the polymeric layer. In an embodiment, the polymeric layer overlies and directly contacts the fluoropolymer layer without any intervening layer or layers. The application of the polymeric layer is typically dependent upon the material used. For instance, the polymeric layer may be processed. Processing of the polymeric layer, particularly thermoplastics, may include casting, coating, extruding, or skiving. For instance, the composite structure may be formed through a method similar to traditional film coating methods. In an embodiment, coating methods include, but are not limited to, extrusion coating, Knife Over Roll and Reverse Roll coating heads. Any reasonable coating method is envisioned. In an embodiment, the polymeric layer may be a solvated thermoplastic or thermoset material. The solvated thermoplastic or thermoset material is typically processed on a coater that supplies sufficient time and temperature for drying (volatilizing solvent) and any curing of the material.

In an embodiment, the composite structure may include a reinforcing layer. The method of disposing the reinforcing layer is dependent upon the material of the reinforcing layer as well as the layers it directly contacts. Any suitable method may be envisioned. In an embodiment, the reinforcing layer may be laid on the polymeric layer. In another embodiment, the reinforcing layer may be laid between the fluoropolymer layer and the polymeric layer prior to providing the polymeric layer. In a further embodiment, a reinforcing layer may be provided within the polymeric layer, for instance a commercially available material may include a reinforcing layer substantially embedded within the polymeric layer.

In an embodiment, the composite structure may include a slip layer. Any reasonable method may be used to place the slip layer on the composite structure. The method is typically dependent on the specific material used for the slip layer. For instance, the slip layer may be cast, coated, extruded, melted, or laminated. In a particular embodiment, the slip layer may be coated, such as by gravure coating. When coated, the slip layer may by dried and cured.

The final steps of forming the composite structure may include stripping the composite structure from the carrier, when a carrier is used. The composite structure may be trimmed to any size envisioned. In a particular embodiment, the composite structure may be up to 1.5 meters wide.

Once formed, particular embodiment of the above-disclosed composite cushioning material advantageously exhibit desired properties. For instance, the composite layers have uniform thickness and compression deflection. Further, the materials of the composite layers are typically chosen such that they have similar coefficients of thermal expansion. Desired properties may include anti-static properties, thermal resistance and the number of cycles an area can withstand during the heat sealing conditions. A cycle is defined as one time under heat and pressure and one time in a “rest” position. Typically, each specific time of the hot press can vary between manufacturers and parts being manufactured. In an exemplary embodiment, a total cycle may be about 5 seconds to about 15 seconds of the hot press in contact with the electronic components with the heat seal platen at a temperature of about 330° C. to about 400° C. and a pressure of about 3.0 MPa to about 5.0 MPa. The hot press may then be at rest for about 1 second to about 5 seconds. In an embodiment, the average total cycle time is about 20 seconds. In a particular embodiment, the composite structure may withstand at least about 15 cycles, such greater than about 30 cycles, such as greater than about 40 cycles, or even greater than about 80 cycles without property or other physical changes that negatively impact its cushion and release properties. According to an embodiment, the ability of the structure to withstand the above-described heat cycling is determined based on visual inspection, more specifically, visual inspection unassisted by magnification for detection of physical degradation of the structure.

In an embodiment, the composite structure has a desirable thermal resistance during the hot press cycles. For instance, the thermal resistance may be about 0.85 W/mK to about 1.15 W/mK, as measured in accordance with ASTM E-1530. In an embodiment, the composite structure can withstand low compression set during the hot press cycles.

For cushioning/leveling for the heat seal process of electronic components, the composite material has desired release properties from the tool head, i.e. heat platen, the electronic components, and anisotropic conductive film (ACF). In particular, the slip layer of the composite structure is in direct contact with the heat platen of the heat seal press. In another embodiment, when the slip layer is not present, the polymeric layer may be in direct contact with the heat platen. Typically, a heat platen is a material such as a ceramic or a metal, such as carbon steel. The composite structure has release properties to the heat platen, i.e. does not stick. Particularly, the layer of the composite structure that directly contacts the heat platen, i.e. the slip layer or polymeric layer, has release properties that withstand multiple hot press cycles of temperatures of about 330° C. to about 400° C. at pressures of 3 MPa to about 5 MPa. Further, when the composite structure is in contact with any electronic component and anisotropic conductive film (ACF), it has desirable release properties and does not stick over multiple cycles of temperature and pressure. For instance, the fluoropolymer layer may be in direct contact with the electronic component to be bonded. Particularly, the fluoropolymer layer in contact with the electronic component has release properties that withstand temperatures at the site of the bond line between the fluoropolymer layer and electronic components, i.e. a bond line temperature of about 175° C. to about 200° C. at pressures of 3 MPa to about 5 MPa.

Any further applications of the composite structure include, for example, uses when the properties such as the above-mentioned antistatic properties, thermal resistance, and/or cushioning properties are desired. The composite material may also possess other properties desired for any particular application envisioned.

### EXAMPLES

### Example 1

An exemplary sample is produced on a support material. First, a PTFE film is fused cast at about 0.25 mils onto a polyimide film (about 3 mils to 5 mils), which is used as a carrier. This is done using a standard dip coating method of a PTFE. The film, cast PTFE on the polyimide carrier is chemically etched with a sodium naphthalene etch.

The etched film still on the carrier is then coated with a liquid silicone rubber at a thickness of about 7.0 mils to about 25.0 mils, dried (if necessary) and cured. The liquid silicone rubber is commercially available as a two-part platinum cured LSR having a Shore A durometer of 70. The composite, still with the carrier, is then coated with an antistatic/slip coating that includes Dow Corning® 3715 Topcoat having a thickness of not greater than about 1.0 mils. This composite, still with the carrier, is then converted by stripping the polyimide carrier away from the composite. The composite is then trimmed to size.

### Example 2

An exemplary composite material is produced with fiberglass reinforcement. For instance, a coating of a cross-linkable liquid silicone rubber (LSR) can take several versions with the supported version. In a first version, a fiberglass fabric is fed through the coating head at the same time the cast PTFE/carrier film so that the fiberglass fabric is in intimate contact with the cast PTFE. The liquid silicone rubber is driven through the fiberglass fabric by the geometry of the web path to the oven. In an embodiment, the fiberglass fabric is substantially embedded within the cross-linkable liquid silicone rubber. The oven is at a temperature and line speed sufficient to dry and cure to liquid silicone rubber. An additional skim coating of liquid silicone rubber is then put on top of the cured silicone to eliminate any texture imparted by the fabric. The finishing steps are similar to the composite in EXAMPLE 1.

In another embodiment, the placement of the fiberglass fabric in the composite can be controlled by coating and curing a thin coat of silicone of about 1.0 mil to about 7.0 mils. The fiberglass fabric is then fed on top of the cured silicone and a second amount of silicone is applied to the top of the fabric. The second coat of silicone is then dried and cured. In this embodiment, the fabric can be in varying distances of thickness away from the cast PTFE side of the composite.

### Example 3

A third exemplary sample is a film of an etched PTFE fabric (supplied by SGPPL Kilrush, Ireland), which is sodium naphthalene etched. All the steps are the same as above without the use of a carrier. For example, the etched film is then coated with a two-part platinum cured LSR having a shore A durometer of 70, dried (if necessary) and cured. The composite is then coated with an anti-static, slip coating that includes Dow Corning® 3715 Topcoat having a thickness of not greater than about 1.0 mils.

All three samples show release properties to the heat platen and electronic components during a hot seal press at a temperature of about 370° C. at a pressure of about 5.0 MPa. The hot press and the composite cushioning structure is in contact with the electronic components for about 15 seconds with a rest time of about 5 seconds. The three samples can withstand at least 15 cycles. The reinforced sample of EXAMPLE 2 can withstand greater than 80 cycles.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

1. A composite cushioning structure comprising:
a fluoropolymer layer having a major surface; and
a polymeric layer overlying the major surface of the fluoropolymer layer;
wherein the composite structure can withstand a hot press at a temperature of at least about 330° C. to about 400° C. and a pressure of about 3 MPa to about 5 MPa for at least about 15 cycles.

2. The composite structure of claim 1, wherein the fluoropolymer is selected from the group consisting of a polytetrafluoroethylene (PTFE), fluorinated ethylene propylene copolymer (FEP), a copolymer of tetrafluoroethylene and perfluoropropyl vinyl ether (PFA), a copolymer of tetrafluoroethylene and perfluoromethyl vinyl ether (MFA), an ethylene tetrafluoroethylene copolymer (ETFE), an ethylene chlorotrifluoroethylene copolymer (ECTFE), polychlorotrifluoroethylene (PCTFE), polyvinylidene fluoride (PVDF), and a tetrafluoroethylene hexafluoropropylene vinylidene fluoride terpolymer (THV).

3. The composite structure of claim 2, wherein the fluoropolymer is polytetrafluoroethylene (PTFE).

4. (canceled)

5. The composite structure of claim 1, wherein the polymeric layer is a thermoset material or a thermoplastic material.

6. The composite structure of claim 5, wherein the polymeric material includes liquid silicone rubber (LSR) or high consistency gum rubber (HCR).

7. The composite structure of claim 1, wherein the polymeric layer includes a thermally conductive filler present at up to about 75% by weight of the total weight of the polymeric layer.

8. The composite structure of claim 7, wherein the thermally conductive filler is aluminum trihydroxyide (ATH), aluminum oxide (AlO₂), boron nitride, iron oxide, carbon black, or combinations thereof.

9. (canceled)

10. The composite structure of claim 1, further comprising a reinforcing layer in contact with the polymeric layer.

11. The composite structure of claim 10, wherein the reinforcing layer includes synthetic fibers, natural fibers, or combination thereof.

12. (canceled)

13. The composite structure of claim 1, further comprising a slip layer overlying the polymeric layer.

14. The composite structure of claim 13, wherein the slip layer includes a thermoset material or thermoplastic material.

15. The composite structure of claim 14, wherein the slip layer includes a cross-linkable liquid silicone rubber (LSR).

16. The composite structure of claim 13, wherein the slip layer further includes an anti-slip additive.

17. The composite structure of claim 16, wherein the anti-slip additive is carbon black.

18. (canceled)

19. The composite structure of claim 1, having a thermal resistance of about 0.85 W/mK to about 1.15 W/mK as measured in accordance with ASTM E-1530.

20. The composite structure of claim 1, wherein the polymeric layer directly contacts the fluoropolymer layer.

21. A composite cushioning structure comprising:
a fluoropolymer layer having a major surface;
a polymeric layer overlying the major surface of the fluoropolymer layer, the polymeric layer including a thermally conductive filler present at up to about 75% by weight of the total weight of the polymeric layer;
wherein the composite structure can withstand a hot press at a temperature of at least about 330° C. to about 400° C. and a pressure of about 3 MPa to about 5 MPa for at least about 15 cycles.

22. The composite structure of claim 21, wherein the fluoropolymer is selected from the group consisting of a polytetrafluoroethylene (PTFE), fluorinated ethylene propylene copolymer (FEP), a copolymer of tetrafluoroethylene and perfluoropropyl vinyl ether (PFA), a copolymer of tetrafluoroethylene and perfluoromethyl vinyl ether (MFA), an ethylene tetrafluoroethylene copolymer (ETFE), an ethylene chlorotrifluoroethylene copolymer (ECTFE), polychlorotrifluoroethylene (PCTFE), polyvinylidene fluoride (PVDF), and a tetrafluoroethylene hexafluoropropylene vinylidene fluoride terpolymer (THV).

23. The composite structure of claim 22, wherein the fluoropolymer is polytetrafluoroethylene (PTFE).

24. The composite structure of claim 21, wherein the polymeric layer is a thermoset material or a thermoplastic material.

25. The composite structure of claim 24, wherein the polymeric material includes liquid silicone rubber (LSR) or high consistency gum rubber (HCR).

26. The composite structure of claim 21, wherein the thermally conductive filler is aluminum trihydroxyide (ATH), aluminum oxide (AlO₂), boron nitride, iron oxide, carbon black, or combinations thereof.

27. The composite structure of claim 21, further comprising a reinforcing layer in contact with the polymeric layer.

28. (canceled)

29. A composite cushioning structure comprising:
a polytetrafluoroethylene layer having a major surface;
a liquid silicone rubber layer overlying the major surface of the polytetrafluoroethylene layer;
a reinforcing layer in contact with the liquid silicone rubber layer; and
an anti-static, slip layer of a liquid silicone rubber overlying the reinforcing layer.

30. The composite structure of claim 29, wherein the composite structure can withstand a hot press at a temperature of at least about 330° C. to about 400° C. and a pressure of about 3 MPa to about 5 MPa for at least about 15 cycles.

31-5. (canceled)
